(19) United States
(12) Patent Application Publication
(10) Pub. No.: US 2010/0087934 A1
(43) Pub. Date: Apr. 8, 2010

(54) Fuel Cell System and Adaptive Open-Loop and Closed-Loop Control Method and Apparatus Therefor

(76) Inventors: Joachim Blum, Stuttgart (DE); Arnulf Sponheimer, Stuttgart (DE); Su Zhou, Shanghai (CN)

Correspondence Address: CROWELL & MORING LLP;INTELLECTUAL PROPERTY GROUP, P.O. BOX 14300, WASHINGTON, DC, 20044-4300, US

(21) Appl. No.: 12/442,057

(22) PCT Filed: Sep. 20, 2006
(86) PCT No.: PCT/EP2006/009140

§ 371 Date: Dec. 22, 2009

(51) Int. Cl. G05B 13/02

(52) U.S. Cl. 700/32

(57) ABSTRACT

Closed-loop and open-loop systems are used for automated control of the operation of arbitrary systems. An open-loop control apparatus, which controls at least one controlled variable of a system such as a fuel cell system, has a pilot control module and an associated storage module, for storing pilot control characteristic data. The pilot control module carries out pilot control, based on a pilot control value determined from a desired value of the controlled variable from the pilot control characteristic data. A closed-loop control module performs closed-loop control of the controlled variable using a controlled portion determined on the basis of the actual value of the controlled variable. In the open-loop control apparatus, the pilot control value and the controlled portion each make respective contributions to a manipulated variable. An adaptation module matches the pilot control characteristic data in the storage module adaptively during the run time of the open-loop control apparatus.

This application is a national stage of International Application No. PCT/EP2006/009140, filed Sep. 20, 2006, the entire disclosure of which is herein expressly incorporated by reference.

The present invention relates to an open-loop and closed-loop control apparatus for controlling at least one controlled variable of a fuel cell system, and to a method for controlling at least one controlled variable of a fuel cell system.

Closed and open-loop systems are used for automated control of the operation of many types of systems. Such controls are particularly important in the field of vehicle technology.

German patent document DE 101 600 51 A1 discloses for example, a method and apparatus for monitoring a motor vehicle subsystem by determining an actual operating variable of a subsystem of the vehicle to assess its functionality, and outputting a control signal according to the requirement of the assessment result. An operating state of the motor vehicle is adjusted according to the requirement of the control signal. The actual operating variable of the subsystem is determined via predetermined characteristics, which for example output a corresponding actual engine torque dependent on a sensed wheel force component. The characteristics can optionally be matched adaptively; they are generated or changed during the course of the operating time of the entire system, so that connections between the sensed wheel force component and the effective actual engine torque can always be taken exactly therefrom.

German patent document DE 4228053 A1 relates to a method for the cylinder-specific characteristic control and adaptation for the electronic control of internal combustion engines with multiple cylinders. This method, which uses only an open-loop control, provides that a used characteristics field is continually adaptively optimized at the points of the parameter space given by the operating parameters of the respective individual cylinders, with regard to at least one target variable.

From closed-loop control technology, it is known that, in regulated systems (particularly non-linear systems), a control device is used which simultaneously uses both open loop control of the manipulated variables by means of a characteristic curve or characteristic field, and regulation (closed-loop control) of the manipulated variables by means of an additive regulating portion. Open-loop control (pilot control) has the advantage that it permits direct access to the manipulated variables (and thereby the controlled variables), so that very high dynamics can be achieved. On the other hand, the use of PID or condition controllers to generate the additive controlled portion make it possible to readjust slow dynamic or stationary system conditions. Such open-loop control devices form the closest state of the art.

One object of the invention is to provide an open-loop control apparatus which is improved relative to the closed-loop quality.

Another object of the invention is to provide a corresponding system in the form of a fuel cell system, a corresponding method, and a corresponding computer program.

These and other objects and advantages are achieved by the open-loop and closed-loop control apparatus according to the invention, which is suitable or configured to control at least one controlled variable of a system. The system in this case may be a non-linear system (or a fuel cell system). At least one controlled variable of the system is controlled; however, two or more controlled variables of the system can also be controlled, either independently of one another, or partially in mutual dependence upon one another.

The open-loop and closed-loop control apparatus is preferably formed as an electronic processing device, for example as a control device, personal computer, microcontroller, DSP embedded system or the like.

The open-loop control apparatus comprises a pilot control module and an associated storage module for storing pilot control characteristic data. The pilot control module permits direct access to the controlled variable of the system, so that the pilot control reacts without (or nearly without) delay upon a fast operating point change of the system. The pilot control module is configured so that a pilot control value is determined on the basis of a desired value of the controlled variable, from the stored pilot control characteristic data.

The open-loop control apparatus further comprises a closed-loop module (for example, a PID or condition controller), with the open-loop module being formed for controlling the controlled variable. The open-loop module updates a deviation of the controlled variable from the guide variable (desired value presetting) via a sensor system.

The open-loop control apparatus is formed using program technology and/or circuitry, configured such that the pilot control value and the controlled portion provide respective contributions to a control value, which is (or can be) used to control the at least one controlled variable of the system. The pilot control module and the closed-loop module can thus be arranged in parallel to one another, in particular in such a manner the pilot control value and the controlled portion are added to form the control value. Alternatively, the pilot control value and the control value of the manipulated variable may be supplied at the input of the closed-loop module, so that the pilot control value provides a contribution to the control value in this manner.

According to the invention, an adaptation model is provided in the open-loop control apparatus, which is formed to match the pilot control characteristic data in the storage module adaptively during the run time of the open-loop control apparatus or the system.

The inventors have determined that the combination of closed-loop mode and pilot control is principally capable of controlling systems, even with pilot control characteristic data which are defective or obsolete due to wear or varying system tolerances. However, the control dynamics of the system are adversely affected due to the adjustment of these faults by the closed loop. An exact pilot control is enabled by the use of adaptive pilot control characteristic data, such that the controlled portion is near zero in the ideal case, ensuring robust system behavior in any case, with quickly adjustable system conditions. The controlled portion, and therewith the controlled deviation, are thereby at least limited to a small region with the open-loop control apparatus according to the invention.

In a preferred embodiment, the pilot control characteristic data may comprise a one-dimensional characteristic, a two- or multi-dimensional characteristic field, a corresponding raster characteristic or characteristic field. In a practical realization, for example, the pilot control characteristic data are stored in the storage module as a look-up table (LUT). Moreover, the pilot control characteristic data may be composed of a basic characteristic/characteristic field and a delta characteristic/characteristic field, with only the delta characteristic/characteristic field being changed by the adaptation. The storage and change of the pilot control characteristic data are technically solved, for example by describing the characteristic field/characteristic contents in the RAM/ROM storage region of the storage module. The storage contents are thus preferably still present in the storage module (preferably in a persistant manner), after switching the open-loop control apparatus off and on again.

In a particularly preferred embodiment of the invention, the adaptation module is formed for the adaptation of the pilot control characteristic data on the basis of stationary or virtually stationary controlled portions. The present invention thus provides pilot control characteristic data (in particular characteristic field or delta characteristic field) that are adjustable for the run time, by changing the preset characteristic field contents in the respective operating point by the in particular stationary controlled portion.

The adaptation process is preferably carried out on the basis of controlled portions, which are taken from the closed loop module and/or the system in a stationary and/or virtually stationary condition. In a preferred embodiment, it is checked by means of a routine if the system is in a stationary condition, and the controlled portion, which adjusts by means of the closed-loop module, is determined and consulted for adaptation.

The adaptation model is preferably configured such that the adaptation of the pilot control characteristic data is converted by a surface interpolation method, or, in the case of a characteristic, by a linear interpolation method. In this case, preferably the stationary controlled portion is converted to present support points of the pilot control characteristic data, and the resulting portion is added to the updated support value in the case of a characteristic field/characteristic. Alternatively, it is inserted directly as a delta value to the basic characteristic field in the case of a delta characteristic field.

In a preferred further embodiment of the closed-loop control apparatus, the adaptation module is formed in such a manner that the adaptation degree of the pilot control characteristic data (in particular, the adaptation per adaptation iteration) is smaller than 1 (100%), preferably in the region of 1% to 50%, so as to avoid feedbacks of the controller with the pilot control module during the adaptation process. This measure at least substantially decouples the adaptation process from the closed-loop apparatus, by keeping the measure of the adaptation small.

Alternatively and/or additionally, the pilot control characteristic data are adapted only for these support points which are not currently in the region of the operating point of the system (that is, are for example time-delayed). The pilot control characteristic data are for example only updated after leaving the respective operating points.

With a preferred practical realization of the open-loop control apparatus for a fuel cell system, the controlled variable is formed in such a manner that it acts on one or more of the following systems: an air compressor, an exhaust gas throttle flap, a humidifier bypass throttle flap, control valves and/or a recirculation pump of the fuel cell system. The open-loop control apparatus is particularly suitable for triggering components, whose system properties depend heavily on changing environmental conditions or wear and/or aging.

A further object of the invention relates to a method of con oiling at least one controlled variable of a system (particularly a fuel cell system), using an open-loop and closed-loop control apparatus.

With the method of the invention, a pilot control value is determined from stored pilot control characteristic data based on a desired value of the controlled variable, and a controlled portion may possibly be determined in addition to the pilot control value, based on the desired value. A control value is formed on the basis of the pilot control value and the controlled portion.

In the method according to the invention, the pilot control characteristic data are matched adaptively during the run time of the system. The present invention thereby provides a characteristic field or delta characteristic field which can be adjusted to the run time, with the preset characteristic field contents being changed in the respective operating point in particular by a stationary controlled portion.

In a preferred embodiment of the method, it is first checked via a routine if the system is in a stationary condition. The controlled portion which is adjusted by the controller is then determined, which is consulted for the adaptation of the pilot control characteristic data in a further step.

A further object of the invention relates to a computer program with program code means for executing the method according to the invention, when the computer program is executed on a computer or an open-loop control apparatus.

Other objects, advantages and novel features of the present invention will become apparent from the following detailed description of the invention when considered in conjunction with the accompanying drawings.

### BRIEF DESCRIPTION OF THE DRAWINGS

The single FIGURE is a block diagram of an open-loop control apparatus according to an embodiment of the invention.

### DETAILED DESCRIPTION OF THE DRAWINGS

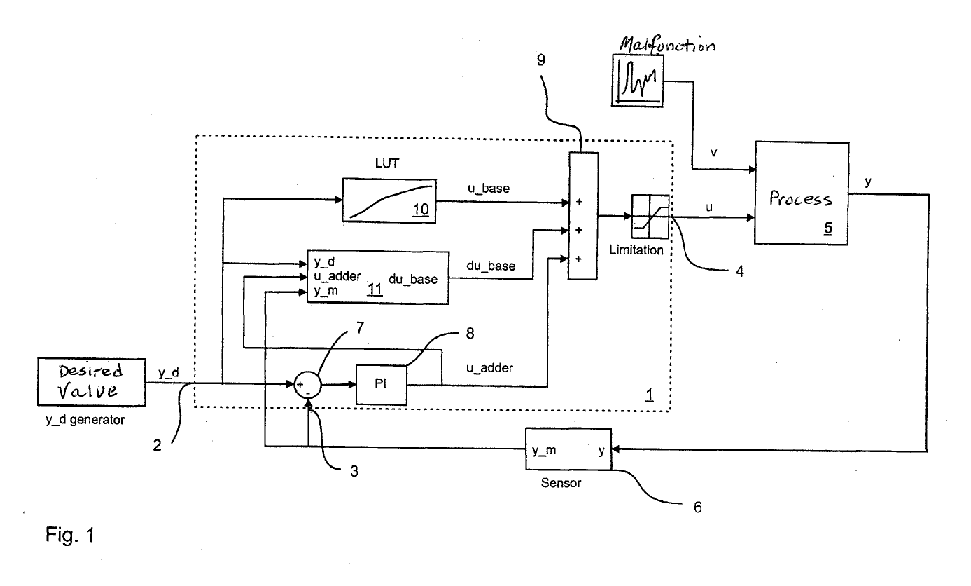

FIG. 1 shows an open-loop control apparatus 1 in the form of a block diagram as a first embodiment of the invention. The open-loop control apparatus 1 has a first input 2, for the reception of a desired value y_{d}. A second input 3 serves for the reception of an actual value yₘ. The open-loop control apparatus 1 comprises a control value output 4, at which the determined control value u is provided. The open-loop control apparatus 1 thus corresponds to a classical open-loop or closed-loop device with regard to inputs and outputs, in which a measured actual value yₘ (or which is obtained in another manner) follows a desired value y_{d} by generating and outputting a control value u.

The closed-loop or open-loop system 5 is for example formed as one or more components of a fuel cell system (not shown). The closed-loop system 5 comprises a controlled variable y which is acted on by the control value u via an actuator (not shown), and possibly by malfunctions v. The actual value of the controlled variable y is measured by a sensor 6, which generates the actual value yₘ on the basis of the measurement, and applies it to the second input 3. Only one controlled variable y and a sensor 6 were chosen for the simplified depiction of the example of the embodiment. However, several control variables y dependent on one another (or also independent), can be regulated or controlled simultaneously with more complex embodiments. Also, the actual value of the controlled variable y can be determined by other methods, such as relative measurement, derivation, estimation or the like.

The open-loop control apparatus 1 comprises two parallel signal paths starting from the inputs 2 and 3. A first signal path comprises a closed-loop device, and the second path comprises a pilot control.

The actual value yₘ and the desired value y_{d} of the controlled variable y are combined in the first signal path in a differential member 7, and the closed-loop difference is passed to a controller 8, which determines a controlled portion u_{adder}. The latter is finally passed to an adder 9, which merges the controlled portion with other values, as will be explained in the following.

The second signal path, relating to the pilot control, is divided into two sub-paths which deliver a pilot control value u_{base} or du_{base} to the adder 9.

The sub-path positioned further upwards in FIG. 1 guides the desired value y_{d} from the first input 2 to a look up table (LUT) module 10, in which a basic characteristic field is stored. The pilot control value u_{base} is determined by the desired value y_{d} from the basic characteristic field in the LUT model 10, and—as already explained—passed to the adder 9.

The lower sub-path in FIG. 1 guides the desired value y_{d} to a dLUT module 11, which has a delta characteristic field. In the dLUT module 11, a delta pilot control value du_{base} is assigned to the desired value y_{d}, which is again passed to the adder 9.

While the basic characteristic field in the LUT module remains unchanged over time in the present example of an embodiment in FIG. 1, the delta characteristic field in the dLUT module 11 is adapted in response on temporal changes of the closed-loop system 5 (for example wear, aging, contamination etc.). The division of a pilot control module into LUT module 10 and dLUT module 11 is not compulsory. Rather, the basic characteristic field and the delta characteristic field can just the same be merged to a common characteristic field, which is matched to the closed-loop system 5 adaptively during the run time. It is also possible that the characteristic field is formed only one-dimensional, that is, as a characteristic, or comprises two, three or more dimensions.

For the adaptation of the delta characteristics field in the dLUT module 11, the currently measured actual value yₘ and the current controlled portion u_{adder} are added to the desired value y_{d}. As explained in more detail hereinafter, the delta characteristic field in the respective operating point yₘ is changed by the controlled portion u_{adder}. The adaptation is based on the proposition that the controlled portion should strive to zero in an optimally adjusted delta characteristic field. The magnitude of the controlled portion is thereby a measure of the quality (in particular, the up-to-dateness) of the delta characteristic field. The delta characteristic field is corrected with the controlled portion u_{adder} in the operating point yₘ or in the corresponding support point for the adaptive adaptation of the delta characteristic field. It is ensured during the transfer, that the controlled portion u_{adder} is formed in an engaged manner, that is, stationary or virtually stationary. So as to avoid a feedback between the control module 8 and the pilot control module 10 or 11, the adaptation degree (a measure of the adaptation of the pilot control value in the characteristic field) is chosen to be significantly smaller than 1 (100%) and/or a temporal decoupling of the adaptation of the characteristic field value is provided in the respective operating point.

A mathematical derivation of the adaptation process is introduced in the following for the best explanation of the adaptation process, which represents a possible execution or depiction of the adaptation process:

The open-loop control apparatus 1 comprises the pilot control module which is formed of the LUT model 10 and the dLUT model 11, and which converts a linearized transfer function. In a particularly practical embodiment, the transfer function is represented by a pilot control function u_{base}=LUT(y_{d}). The open-loop control apparatus 1 can be seen as a look-up table (LUT)-based controller for non-linear processes in this case.

A look-up table (LUT) is a condition field from the mathematical point of view, which can be described as follows: {u_{base}(i)=LUT(y_{d}(i)),i= 1̅,̅N̅}, wherein the control values y_{d}(i)⊂R^{1U2} are copied to the control values u_{base}(i)⊂R, wherein the condition field has for example been determined by offline measurements.

As the depicted look-up table is shown as a raster field or raster characteristic, values between the raster points or support points are determined by an interpolation method.

As mostly only look-up tables for one-dimensional or two-dimensional fields are needed for practical use, only these are depicted in the following. Look-up tables having higher dimensions can nevertheless also be used in principle.

For a one-dimensional look-up table

{u_{base}(i)=LUT(y_{d}(i)),i= 1̅,̅N̅}

e.g., in the form:

| | | | | | | |
|---|---|---|---|---|---|---|
| y_{d} | y_{d}(1) | . . . | y_{d}(k) | y_{d}(k + 1) | . . . | y_{d}(N) |
| u_{base} | u_{base}(1) | . . . | u_{base}(k) | u_{base}(k + 1) | . . . | u_{base}(N) |

the pilot control value u_{base} at the time t is calculated as follows:

u_{base}(t)=lₖu_{base}(k)+lₖ₊₁u_{base}(k+1)

wherein the weighting factors are calculated as follows:

$$0 < {l}_{k} = \frac{{y}_{d} ( k + 1 ) - {y}_{d} ( t )}{{y}_{d} ( k + 1 ) - {y}_{d} ( k )} \leq 1 , \\ 0 < {l}_{k + 1} = \frac{{y}_{d} ( t ) - {y}_{d} ( k )}{{y}_{d} ( k + 1 ) - {y}_{d} ( k )} < 1.$$

For two-dimensional look-up tables, which are displayed as follows:

{u_{base}(i, j) = LUT(y_{td}(i), y_{2d}(j)), i = 1̅,̅N̅, j = 1̅M̅}, e.g.,

| | | | | | | |
|---|---|---|---|---|---|---|
| u_{base}(i, j) | y_{1d}(1) | . . . | y_{1d}(k) | y_{1d}(k + 1) | . . . | y_{1d}(M) |
| y_{2d}(1) | u_{base}(1, 1) | u_{base}(1, . . . ) | u_{base}(1, k) | u_{base}(1, k + 1) | u_{base}(1, . . . ) | u_{base}(1, M) |
| $⋮$ | ${u}_{base} ( ⋮ , 1 )$ | ${u}_{base} ( ⋮ , . . . )$ | ${u}_{base} ( ⋮ , k )$ | ${u}_{base} ( ⋮ , k + 1 )$ | ${u}_{base} ( ⋮ , . . . )$ | ${u}_{base} ( ⋮ , M )$ |
| y_{2d}(l) | u_{base}(l, 1) | u_{base}(l, . . . ) | u_{base}(1, k) | u_{base}(1, k + 1) | u_{base}(l, . . . ) | u_{base}(l, M) |
| y_{2d}(l + 1) | u_{base}(l + 1, 1) | u_{base}(l + 1, . . . ) | u_{base}(l + 1, k) | u_{base}(l + 1, k + 1) | u_{base}(l + 1, . . . ) | u_{base}(l + 1, M) |
| $⋮$ | ${u}_{base} ( ⋮ , 1 )$ | ${u}_{base} ( ⋮ , . . . )$ | ${u}_{base} ( ⋮ , k )$ | ${u}_{base} ( ⋮ , k + 1 )$ | ${u}_{base} ( ⋮ , . . . )$ | ${u}_{base} ( ⋮ , M )$ |
| y_{2d}(N) | u_{base}(N, 1) | u_{base}(N, . . . ) | u_{base}(N, k) | u_{base}(N, k + 1) | u_{base}(N, . . . ) | u_{base}(N, M) |

the control values are calculated according to the following equation:

u_{base}(t)=l_{l,k}u_{base}(l,k)+l_{l+1,,k}u_{base}(l+1,k)+l_{l+1,,k+1}u_{base}(l+1+1,k)+l_{l,k+1}u_{base}(l,k+1)

wherein the weighting factors are formed as follows:

$$\begin{matrix}0 < {l}_{l , k} = \frac{A ( l , k )}{\sum A} \leq 1 , & 0 \leq {l}_{l , k + 1} = \frac{A ( l , k + 1 )}{\sum A} < 1 , \\ 0 \leq {l}_{l + 1 , k} = \frac{A ( l + 1 , k )}{\sum A} < 1 , & 0 \leq {l}_{l + 1 , k + 1} = \frac{A ( l + 1 , k + 1 )}{\sum A} < 1\end{matrix} \} ,$$

and the regions are calculated as follows:

A(l,k)=[y_{1d}(k+1)−y_{1d}][y_{2d}(l+1)−y_{2d}],

A(l+1,k)=[y_{1d}(k+1)−y_{1d}][y_{2d}−y_{2d}],

A(l+1,k+1)=[y_{1d}−y_{1d}(k)][y_{2d}−y_{2d}(l)],

A(l,k+1)=[y_{1d}−y_{1d}(k)][y_{2d}(l+1)−y_{2d}],

Further information regarding the type of pilot control may be found in the scientific article by O. Nelles and A. Fink; Tool for the optimization of raster characteristic fields, 42, (2000), zur Optimierung von Rasterkennfeldern, 42 (2000), issue 5, atp, the disclosure thereof being included here completely by reference in particular in view of the calculation of the pilot control values.

For the purpose of simplicity, the execution of the adaptation process is further shown on the basis of a one-dimensional look-up table. Multi-dimensional characteristic fields or LUTs are matched adaptively in an analogous manner.

With an optimal layout and adjustment of the look-up table, the controlled portion u_{adder} of the control module (8) should ideally be near or equal to 0. The value of u_{adder}(t) is thus in the engaged condition, that is, in the stationary or virtually stationary condition, a characteristic for the exactness of the pilot control characteristic data, in particular for the heights or values of the current operating or support point of adjacent nodes.

An arbitrary desired value y_{d}(∞) requires a control value, which is formed as u_{adder}(∞)+u_{base}(∞) according to FIG. 1. The infinity sign is thereby respectively for the engaged stationary and/or virtually stationary condition.

The necessary control value can also be written as ū_{addee}(∞)+u_{base}(∞)+Δu_{base}(∞). The correction value Δu_{base}(∞) for the pilot control value u_{base}(∞) is necessary, if the value of the controlled portion u_{adder}(∞) is too large. A suitable, new controlled portion ū_{addee}(∞) of the control module 8 should correspondingly be achieved by the correction value Δu_{base}(∞). Due to the identity ū_{adder}(∞)+u_{base}(∞)+Δu_{base}(∞)=u_{adder}(∞)+u_{base}(∞) the new controlled portion should be able to be written as follows:

ū_{adder}(∞)=u_{adder}(∞)−Δu_{base}(∞)=u_{adder}(∞)−[lₖΔu_{base}(k)+lₖ₊₁Δu_{base}(k+1)].

The new controlled portion is preferably limited within a narrow band. This condition can be fulfilled by the optimal solution of the following equation:

lₖΔu_{base}(k)+lₖ₊₁Δu_{base}(k+1)=u_{adder}(∞)

As generally known, every equation of the form Ax=b has a solution in the form of x*=A⁺b with the Moore-Penrose pseudo inverse A⁺=A^{T}(AA^{T})⁻¹, the necessary solution of the above equation is given as follows:

Δu*_{base}=L⁺u_{adder}(∞) wherein Δu*_{base}=[Δu*_{base}(k),Δu*_{base}(k+1)]^{T} and the pseudo

inverse is

$${L}^{+} = {\frac{1}{{l}_{k}^{2} + {l}_{k + 1}^{2}} [ {l}_{k} , {l}_{k + 1} ]}^{T} L = [ {l}_{k} , {l}_{k + 1} ] .$$

So as to achieve a suitable distribution of the cooperation of different controlled portions u_{adder} u_{adder}(∞) with the same delta pilot control value Δu*_{base} with different control values y_{d}(∞), a limited updating rate is suggested as follows:

Δu*_{base}=ηL⁺u_{adder}(∞), wherein η=0,01 . . . 0,5=0.01 . . . 0.5.

In the case of the two-dimensional look up tables, the pseudo inverse can be calculated as follows:

$${L}^{+} = \frac{1}{{l}_{l , k}^{2} + {l}_{l + 1 , k}^{2} + {l}_{l + 1 , k + 1}^{2} + {l}_{l , k + 1}^{2}} [ {l}_{l , k} , {l}_{l + 1 , k} , {l}_{l + 1 , k + 1} , {l}_{l , k + 1} ]$$

Δu*_{base}=[Δu*_{base}(l,k),Δu*_{base}(l+1,k),Δu*_{base}(l+1,k+1),Δu*_{base}(l,k+1)]^{T} The adaptive algorithm for updating the pilot control characteristic data can be written altogether as follows:

Step 1: check if the controlled part u_{adder} exceeds a boundary value.

This is for example checked by the condition

$$\{ \vert \frac{d}{d t} [ {y}_{m} ( t ) \frac{1}{{T}_{y} s + 1} ] \vert < {y}_{0}^{limit} \}$$

If the boundary value is exceeded, the adaptation process is initiated, otherwise an adaptation process does not take place;

the immediately adjacent support points of the characteristic field are calculated to the desired value y_{d}(t) in step 2;
the pseudo inverse L⁺ of the evaluation function L is calculated corresponding to the above equations in step 3;
the characteristic field is updated corresponding to the following equation in step 4:

u_{base}^{new}=u_{base}^{old}+Δu*_{base}+ηL⁺u_{adder}(∞)

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-11. (canceled)

12. Open-loop and closed-loop control apparatus for controlling at least one controlled variable of a system, said control apparatus comprising:
a pilot control module with an associated storage module for storing pilot control characteristic data, said pilot control module being configured to carry out pilot control wherein a pilot control value is determined on the basis of a desired value of the controlled variable from the pilot control characteristic data; and
a closed-loop control module, which is configured to perform closed-loop control of the controlled variable, with a controlled portion being determined on the basis of an actual value of the controlled variable; wherein,
the pilot control value and the controlled portion each contribute respectively to a control value or a manipulated variable; and
said control apparatus further comprises an adaptation module, for matching the pilot control characteristic data in the storage module adaptively during the run time of the open-loop control apparatus.

13. The open-loop and closed-loop control apparatus according claim 12, wherein the pilot control characteristic data are formed as one of a characteristic, a characteristic field, and a raster characteristic or raster characteristic field.

14. The open-loop and closed-loop control apparatus according to claim 12, wherein the adaptation module adapts the pilot control characteristic data on the basis of the controlled portion.

15. The open-loop and closed-loop control apparatus according to claim 14, wherein controlled portions used for the adaptation are taken from one of the closed-loop control module and the system with a stationary and/or a virtually stationary condition.

16. The open-loop and closed-loop control apparatus according to claim 12, wherein the pilot control characteristic data are adapted using at least one of a surface interpolation method and a linear interpolation method.

17. The open-loop and closed-loop control apparatus according to claim 12, wherein an adaptation degree of the pilot control characteristic data is less than 100% per adaptation process.

18. The open-loop and closed-loop control apparatus according to claim 12, wherein an adaptation degree of the pilot control characteristic data is in the region of 1% to 50%.

19. The open-loop and closed-loop control apparatus according to claim 12, wherein the adaptation of the pilot control characteristic data takes place only with currently unused pilot control characteristic data.

20. The open-loop and closed-loop control apparatus according to claim 12, wherein the manipulated variable acts on at least one of an air compressor, an exhaust gas throttle flap, a humidifier bypass throttle flap, a pressure control valve and a recirculation pump of a fuel cell system.

21. The control apparatus according to claim 12, wherein said system is a fuel cell system.

22. A method for the control of at least one controlled variable of a system using the open-loop and closed-loop control apparatus according to claim 12, wherein
a pilot control value is determined based on a desired value of the controlled variable from stored pilot control characteristic data;
a controlled portion is determined based on an actual value of the controlled variable;
a control value is formed based on the pilot control value and the controlled portion; and
the pilot control characteristic data are matched in an adaptive manner during a run time of the system.
